(19) United States
(12) Patent Application Publication
(10) Pub. No.: US 2026/0160397 A1
(43) Pub. Date: Jun. 11, 2026

(54) LIGHTING DEVICE FOR A MOTOR VEHICLE, IN PARTICULAR A HEADLAMP FOR A MOTOR VEHICLE

(71) Applicant: HELLA GMBH & CO. KGAA, Lippstadt (DE)

(72) Inventors: Bernd Fischer, Altenbeken (DE); Alexander Klarius, Lippstadt (DE); Christian Schmidt, Paderborn (DE); Andreas Stockfisch, Erwitte (DE)

(21) Appl. No.: 19/414,556

(22) Filed: Dec. 10, 2025

(30) Foreign Application Priority Data
Dec. 10, 2024 (DE) 102024136875.6

(51) Int. Cl. F21S 41/275; B60Q 1/14; F21S 41/153

(52) U.S. Cl. CPC F21S 41/275; B60Q 1/14; F21S 41/153

(57) ABSTRACT

Lighting device for a motor vehicle, in particular a headlamp for a motor vehicle, including a light source configured to generate light, and projection optics configured to project light emitted by the light source into the exterior of the motor vehicle, wherein the projection optics has at least one lens designed as a Fresnel lens, wherein the light source has at least 48 semiconductor elements, each having a light-emitting surface, wherein the light-emitting surfaces of the semiconductor elements are arranged in a matrix-like manner for the targeted generation of pixels of a light distribution.

### CROSS-REFERENCE TO RELATED APPLICATIONS

The present application claims the benefit of German Patent Application 10-2024-136-875.6, filed Dec. 10, 2024, the disclosure of which is incorporated by reference.

### FIELD OF THE INVENTION

The present invention relates to a lighting device for a motor vehicle, in particular a headlamp for a motor vehicle.

### BACKGROUND OF THE INVENTION

Compact, pixelated light sources with small distances between the light-emitting surfaces enable the realization of compact module concepts for headlamps. Corresponding module concepts are also referred to as SSL technology. By directly imaging the light-emitting surface into the traffic area, the desired light distribution, such as glare-free high beam (ADB), can already be achieved without having to manipulate the light pattern by means of primary optics. An example of such a light module can be found in DE 10-2017-105-888 A1. The headlamp described therein comprises a light source with light-emitting diodes (LEDs) arranged in a matrix-like manner and projection optics with two thick convex lenses arranged one behind the other.

In present-day optical projection systems for multi-pixel SSL systems, single lenses with a large central thickness and therefore also a large volume are generally used. An example of such a lighting device is shown in FIG. 11 and FIG. 12. Said lighting device comprises a light source 1, shown only schematically, which is designed as an SSL array. The lighting device further comprises projection optics 2 with three lenses 3, 4, 5, which are designed as single lenses with a large central thickness and therefore also a large volume. Since the weight of a system is closely related to a vehicle's fuel consumption and therefore also its CO₂ emissions, it is appropriate at this point to reduce the weight of these components.

A lighting device of the type mentioned at the beginning is known from DE 11-2013-007-443 B4. The lighting device described therein is designed as a projector-type headlamp in which light emitted by a light source is projected in front of the motor vehicle using projection optics. The lighting device comprises a light-emitting diode (LED), which forms the light source and has a light-emitting surface. The lighting device further comprises two convex lenses arranged in the direction of the optical axis so as to form the projection optics. In this case, one or each of the two convex lenses may be designed as a Fresnel lens.

By designing a convex lens as a Fresnel lens, the weight of the projection optics can be reduced.

### SUMMARY OF THE INVENTION

The problem underlying the present invention is the creation of a lighting device of the type mentioned at the beginning, in which different light distributions can be generated by simple means despite a reduced weight of the projection optics.

According to the invention, this is achieved by a lighting device of the current embodiments.

According to the present disclosure, it is provided that the light source has at least 48 (forty-eight) semiconductor elements, each having a light-emitting surface, wherein the light-emitting surfaces of the semiconductor elements are arranged in a matrix-like manner for the targeted generation of pixels of a light distribution. In this context, the semiconductor elements may be designed as light-emitting diodes (LEDs) or as laser diodes, which can be configured in particular to be controlled independently of one another to generate pixels of a light distribution. The independently of one another controllable light-emitting diodes or laser diodes can be used to generate different light distributions, such as a glare-free high beam, using simple means. Fresnel lenses typically feature fine annular structures. These structures can cause scattered light. Furthermore, color fringes can occur at the fine edges of the structures due to chromatic aberration. It was therefore previously assumed that, although the light of a single light-emitting diode can be projected into the exterior of a motor vehicle by projection optics with a Fresnel lens, the light of several light-emitting diodes or laser diodes cannot be projected into the exterior of a motor vehicle by projection optics with a Fresnel lens in such a way that the desired light distribution can be generated with the necessary accuracy. Surprisingly, however, it has been shown that projection optics with a Fresnel lens or several Fresnel lenses can also project the light emitted by several light-emitting diodes or laser diodes into the exterior of a motor vehicle in such a way that the desired light distribution, such as a glare-free high beam, can be generated with the necessary accuracy.

In this case, the light-emitting surfaces of the semiconductor elements may be arranged in a matrix-like manner in a first direction and in a second direction perpendicular to the first direction, in particular wherein the first direction corresponds to the horizontal direction in the light distribution generated in the exterior of the motor vehicle and wherein the second direction corresponds to the vertical direction in the light distribution generated in the exterior of the motor vehicle.

It is possible for the light source to be designed as a solid-state LED array. It may also be provided for the light source to have more than 48 semiconductor elements, wherein the light source may also be designed, in particular, as a Solid State Lighting-High Definition (SSL-HD) module.

By designing the light source in this way, the lighting device can be configured to generate a low-beam and/or a high-beam distribution, and/or a symbol projection.

It is possible for the projection optics to have one lens designed as a Fresnel lens or two lenses designed as Fresnel lenses. However, it may also be provided for the projection optics to have at least one other lens that is not designed as a Fresnel lens in addition to the at least one lens that is designed as a Fresnel lens.

It is possible that the at least one lens designed as a Fresnel lens is made of plastic or comprises plastic material. In this case, it may be provided that the at least one lens designed as a Fresnel lens is designed as an injection-molded plastic part. The weight of the projection optics can be reduced by making the Fresnel lens from plastic. Injection molding of the Fresnel lens allows cost-effective manufacturing of the projection optics in large quantities.

It is possible that the at least one lens designed as a Fresnel lens is made of polymethyl methacrylate (PMMA) or comprises polymethyl methacrylate (PMMA). It has been shown that polymethyl methacrylate is significantly more color-neutral than polyvinyl chloride (PC). Therefore, when polymethyl methacrylate is used, no color fringes or fewer color fringes occur at the fine edges of the annular structures.

In this case, it may be provided that the polymethyl methacrylate used for manufacturing the at least one lens designed as a Fresnel lens is a high-temperature polymethyl methacrylate (PMMA HT), in particular a polymethyl methacrylate from the company Trinseo under the designation “PMMA Altuglas HT 121”. A Fresnel lens made of a high-temperature polymethyl methacrylate proves to be dimensionally stable even with very fine Fresnel lens structures and the high temperatures in a headlamp.

### BRIEF DESCRIPTION OF THE DRAWINGS

The invention is explained in more detail hereafter with reference to the accompanying drawings. In the figures:

FIG. 1 shows a schematic side view of a first embodiment of a lighting device according to an embodiment of the invention;

FIG. 2 shows a perspective view of the lighting device according to FIG. 1;

FIG. 3 is a top view of a lens of the projection optics of the lighting device according to FIG. 1, designed as a Fresnel lens;

FIG. 4 shows a schematic side view of a second embodiment of a lighting device according to an embodiment of the invention;

FIG. 5 shows a perspective view of the lighting device according to FIG. 4;

FIG. 6 is a top view of a first lens of the projection optics of the lighting device according to FIG. 4, designed as a Fresnel lens;

FIG. 7 is a top view of a second lens of the projection optics of the lighting device according to FIG. 4, designed as a Fresnel lens;

FIG. 8 shows an example of a low-beam distribution generated with a lighting device according to an embodiment of the invention;

FIG. 9 shows an example of a high-beam distribution generated with a lighting device according to an embodiment of the invention;

FIG. 10 shows an example of a high-beam distribution generated with a lighting device according to an embodiment of the invention having a glare-free region;

FIG. 11 shows a schematic side view of a lighting device according to the prior art; and

FIG. 12 shows a perspective view of the lighting device according to FIG. 11.

### DETAILED DESCRIPTION OF THE CURRENT EMBODIMENTS

In the figures, identical and functionally identical parts are provided with the same reference signs.

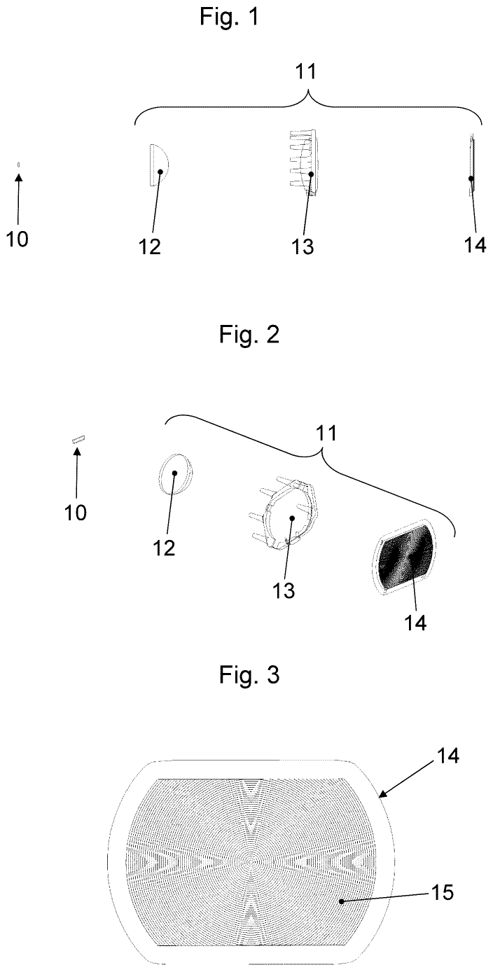

The first exemplary embodiment of a lighting device shown in FIG. 1 and FIG. 2 comprises a light source 10, shown only schematically, and projection optics 11, which is configured to project light emitted from the light source 10 into the exterior of the motor vehicle.

The light source 10 has at least 48 semiconductor elements, each with a light-emitting surface. The semiconductor elements are designed as light-emitting diodes (LEDs) or as laser diodes. The light-emitting surfaces of the semiconductor elements are arranged in a matrix-like manner for the targeted generation of pixels of a light distribution in a first direction and in a second direction perpendicular to the first direction. The first direction may correspond to the horizontal direction in the light distribution generated in the exterior of the motor vehicle, while the second direction may correspond to the vertical direction in the light distribution generated in the exterior of the motor vehicle. Here, the semiconductor elements are configured to be controlled independently of one another to generate pixels of a light distribution.

The light source 10 is designed in particular as a solid-state LED array. The light source 10 may also have more than 48 semiconductor elements. It is also possible for the light source 10 to be designed as an SSL-HD module.

In the illustrated exemplary embodiments, the projection optics 11 have a first, a second, and a third lens 12, 13, 14, which are arranged one behind the other in the direction of propagation of the light emitted by the light source 10, so that the light passes through the lenses 12, 13, 14 one after the other. It may also be provided that the projection optics 11 have more or fewer than three lenses.

In the first embodiment shown in FIG. 1 and FIG. 2, one of the three lenses 12, 13, 14 is designed as a Fresnel lens. This is the outer, third lens 14, which is arranged on the side of the projection optics 11 facing away from the light source 10. It is certainly possible to design one of the other lenses 12, 13 as a Fresnel lens. The lens 14, which is designed as a Fresnel lens, has typical annular Fresnel structures 15 (see FIG. 3).

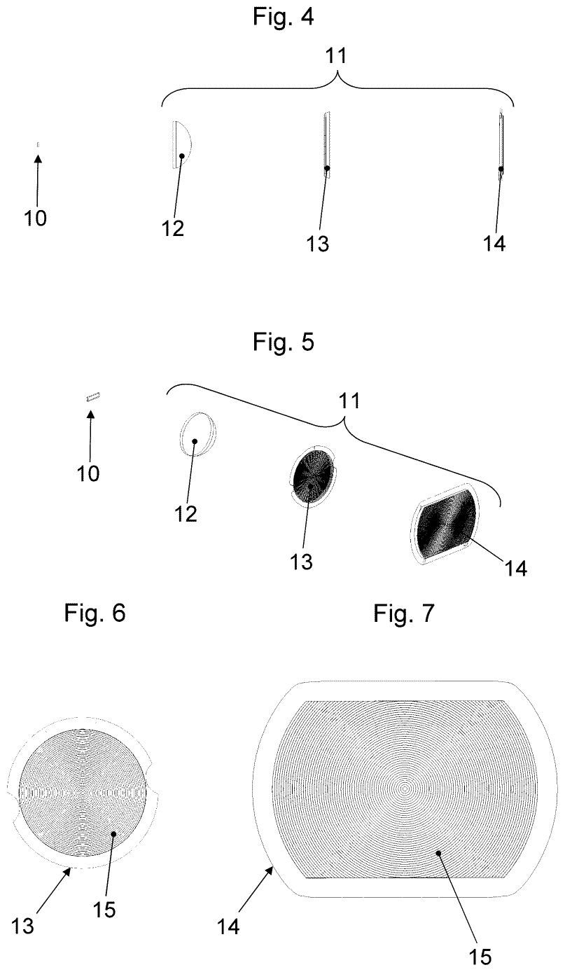

In the second embodiment shown in FIG. 4 and FIG. 5, two of the three lenses 12, 13, 14 are designed as Fresnel lenses. These are the two outer lenses 13, 14 and the second and third lenses 13, 14, respectively, which are arranged on the side of the projection optics 11 facing away from the light source 10. It is certainly possible to design two other lenses 12, 13, 14 as Fresnel lenses. Both the second lens 13, designed as a Fresnel lens, and the third lens 14, designed as a Fresnel lens, have typical annular structures 15 (see FIG. 6 and FIG. 7).

It is still possible to design all lenses 12, 13, 14 of the projection optics 11 as Fresnel lenses.

The at least one lens 13, 14 designed as a Fresnel lens is designed as an injection-molded plastic part. In this case, the at least one lens 13, 14 designed as a Fresnel lens consists of polymethyl methacrylate (PMMA) or comprises polymethyl methacrylate. The polymethyl methacrylate used for manufacturing the at least one Fresnel lens may be a high-temperature polymethyl methacrylate (PMMA HT), in particular, a polymethyl methacrylate from the company Trinseo under the designation “PMMA Altuglas HT 121”.

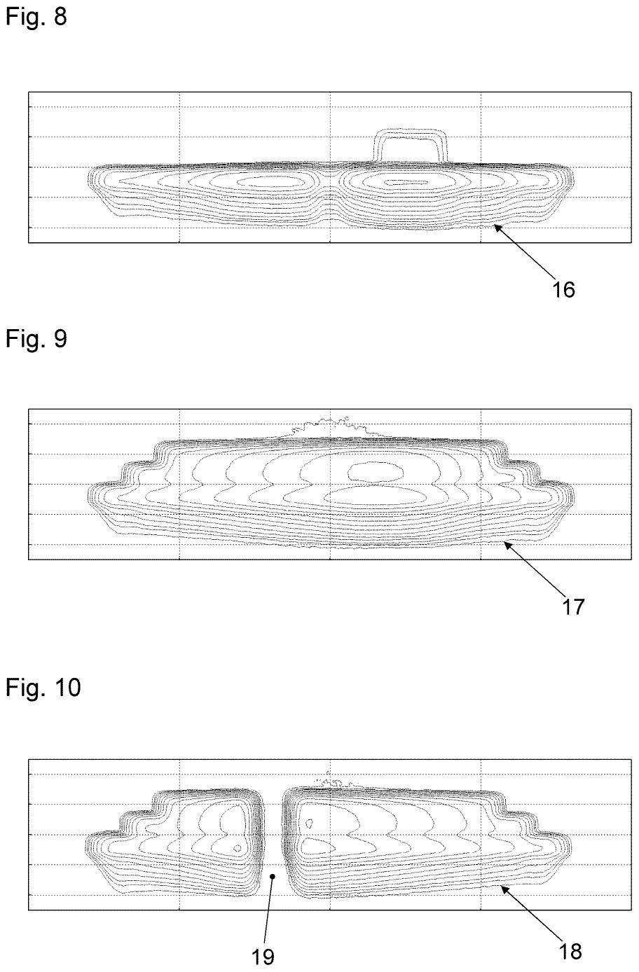

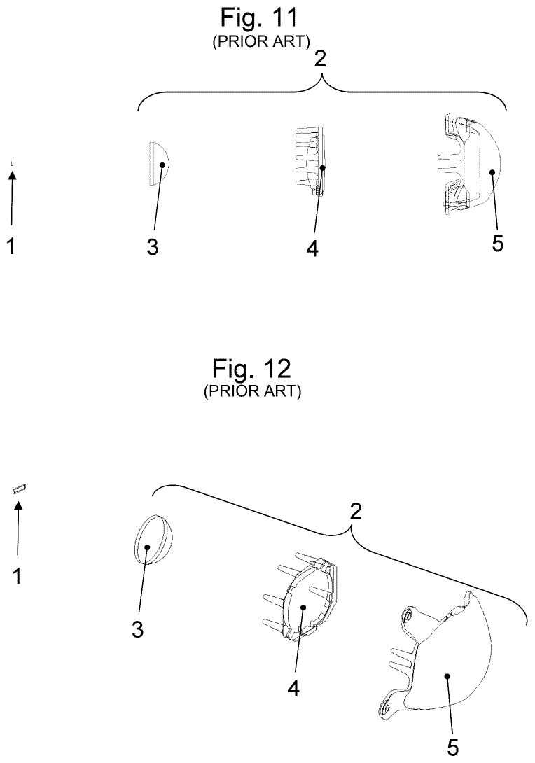

FIG. 8 shows an example of a low-beam distribution 16 generated with a lighting device according to the invention. FIG. 9 shows an example of a high-beam distribution 17 generated with a lighting device according to the invention. FIG. 10 shows an example of a high-beam distribution 18 generated with a lighting device according to the invention having a glare-free region 19.

### LIST OF REFERENCE NUMBERS

1 light source according to the prior art
2 projection optics according to the prior art
3 first lens of the projection optics
4 second lens of the projection optics
5 third lens of the projection optics
10 light source
11 projection optics
12 first lens of the projection optics
13 second lens of the projection optics
14 third lens of the projection optics
15 annular Fresnel structure
16 low-beam distribution
17 high-beam distribution
18 high-beam distribution
19 glare-free region of the high-beam distribution

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A lighting device for a motor vehicle comprising:
a light source configured to generate light; and
projection optics configured to project light emitted by the light source into an exterior of the motor vehicle, wherein the projection optics has at least one lens which comprises a Fresnel lens, wherein the light source has at least forty-eight semiconductor elements, each semiconductor element having a light-emitting surface, wherein the light-emitting surfaces of the semiconductor elements are arranged in a matrix-like manner for targeted generation of pixels of a light distribution.

2. The lighting device according to claim 1, wherein the semiconductor elements are light-emitting diodes or laser diodes.

3. The lighting device according to claim 1, wherein the semiconductor elements are configured to be controlled independently of one another in order to generate pixels of a light distribution.

4. The lighting device according to claim 1, wherein the light-emitting surfaces of the semiconductor elements are arranged in a matrix-like manner in a first direction and in a second direction perpendicular to the first direction, wherein the first direction corresponds to a horizontal direction in the light distribution generated in the exterior of the motor vehicle, and wherein the second direction corresponds to a vertical direction in the light distribution generated in the exterior of the motor vehicle.

5. The lighting device according to claim 1, wherein the light source comprises a solid-state LED array.

6. The lighting device according to claim 1, wherein the light source has more than forty-eight semiconductor elements.

7. The lighting device according to claim 1, wherein the light source comprises an SSL-HD module.

8. The lighting device according to claim 1, wherein the projection optics has one lens comprising a Fresnel lens or has two lenses comprising Fresnel lenses.

9. The lighting device according to claim 1, wherein the projection optics has, in addition to the at least one lens comprising a Fresnel lens, at least one further lens which does not comprise a Fresnel lens.

10. The lighting device according to claim 1, wherein the at least one lens comprising a Fresnel lens is made of plastic or comprises plastic.

11. The lighting device according to claim 10, wherein the at least one lens comprising a Fresnel lens is an injection-molded plastic part.

12. The lighting device according to claim 1, wherein the at least one lens comprising a Fresnel consists of polymethyl methacrylate (PMMA) or comprises polymethyl methacrylate (PMMA).

13. The lighting device according to claim 12, wherein the polymethyl methacrylate used for manufacturing the at least one lens comprising a Fresnel lens is a high-temperature polymethyl methacrylate (PMMA HT).

14. The lighting device according to claim 1, wherein the lighting device is configured to generate at least one of a low-beam distribution, a high-beam distribution, and a symbol projection.
